(19) United States
(12) Patent Application Publication
(10) Pub. No.: US 2017/0343145 A1
(43) Pub. Date: Nov. 30, 2017

(54) High-Pressure Self-Cleaning Elbow

(71) Applicants: Alter NRG Corp., Calgary (CA); Hatch Ltd., Mississauga (CA)

(72) Inventors: Michael Trovant, Toronto (CA); Ian Edward Donohue, Oakville (CA)

(21) Appl. No.: 15/165,582

(22) Filed: May 26, 2016

(51) Int. Cl. F16L 43/00; C10J 3/82; F16L 59/18

(52) U.S. Cl. CPC F16L 43/00; F16L 59/18; C10J 3/82; C10J 2300/0916; C10J 2300/1238; C10J 2300/0946

(57) ABSTRACT

An exhaust elbow includes an inlet, an outlet, a curved gas guiding duct between the inlet and the outlet, and a plurality of thermally insulated stiffeners connected to an external surface of the curved gas guiding duct, each of the stiffeners including a metallic component and thermal insulation adjacent to at least a portion of a surface of the metallic element.

### FIELD OF THE INVENTION

This invention relates to apparatus for directing the flow of gases and to gasification reactors that include such apparatus in associated ductwork.

### BACKGROUND

In various gas handling applications, process and layout constraints often require bends or elbows in the gas handling ductwork to change the direction of gas flow. Some elbows may be simple bends in the ductwork with the same cross-sectional shape as the inlet and outlet ducts. However, certain gas flows, such as those with a high concentration of particulate matter (PM), may demand a different elbow design to avoid particulate build-up within the elbow. Build-up is undesirable for a number of reasons. For example, build-up increases the resistance to flow through the elbow by constricting the cross-sectional flow area. This may increase the power consumption of the fans employed to drive the gas flow, and/or may reduce the gas flow rate through the system. In addition, build-up must often be removed manually, which typically involves shutdown of the gas handling system in order to access the elbow.

There are two principal mechanisms for PM build-up in elbows: impaction of particulate along the walls of the elbows as the walls change direction, which promotes adhesion of PM to the elbow walls; and collection/settling of particles on horizontal or near-horizontal surfaces within the elbow.

Gases that include a high concentration of particulate matter can be produced in gasification reactors, such as those that process municipal solid waste to produce syngas. The ductwork immediately downstream of certain municipal solid waste (MSW) gasifier vessels employs an elbow to re-direct a vertically-upward syngas flow into a generally downward direction. Conventional self-cleaning elbows cannot withstand the high pressures associated with certain MSW gasification exhaust systems. It would desirable to have a self cleaning elbow that can be used in combination with MSW gasifier vessels.

### SUMMARY

In one embodiment, an exhaust elbow includes an inlet, an outlet, a curved gas guiding duct between the inlet and the outlet, and a plurality of thermally insulated stiffeners connected to an external surface of the curved gas guiding duct, each of the stiffeners including a metallic component and thermal insulation adjacent to at least a portion of a surface of the metallic element.

### BRIEF DESCRIPTION OF THE DRAWINGS

FIG. 1 is an isometric view of an example of a gasification reactor including a self cleaning elbow in associated ductwork.

FIG. 2 is an isometric view of another example of a gasification reactor including a self cleaning elbow in associated ductwork.

FIG. 3 is a schematic cross-sectional view of a prior art self cleaning elbow.

FIG. 4 is a cross-sectional view of the elbow of FIG. 3 taken along line 4-4.

FIG. 5 is a side view of a self cleaning elbow in accordance with an embodiment of the invention.

FIG. 6 is a cross-sectional view of a portion of the elbow of FIG. 5.

### DETAILED DESCRIPTION

In one aspect, the present invention relates to self cleaning elbows for directing the flow of gases that may contain particulate matter. Such self cleaning elbows can be used in ductwork associated with gasification reactors.

Plasma gasification reactors (sometimes referred to as PGRs) are a type of pyrolytic reactor known and used for treatment of any of a wide range of materials including, for example, scrap metal, hazardous waste, other municipal or industrial waste and landfill material, and vegetative waste or biomass to derive useful material, e.g., metals, or a synthesis gas (syngas); or to vitrify undesirable waste for easier disposition.

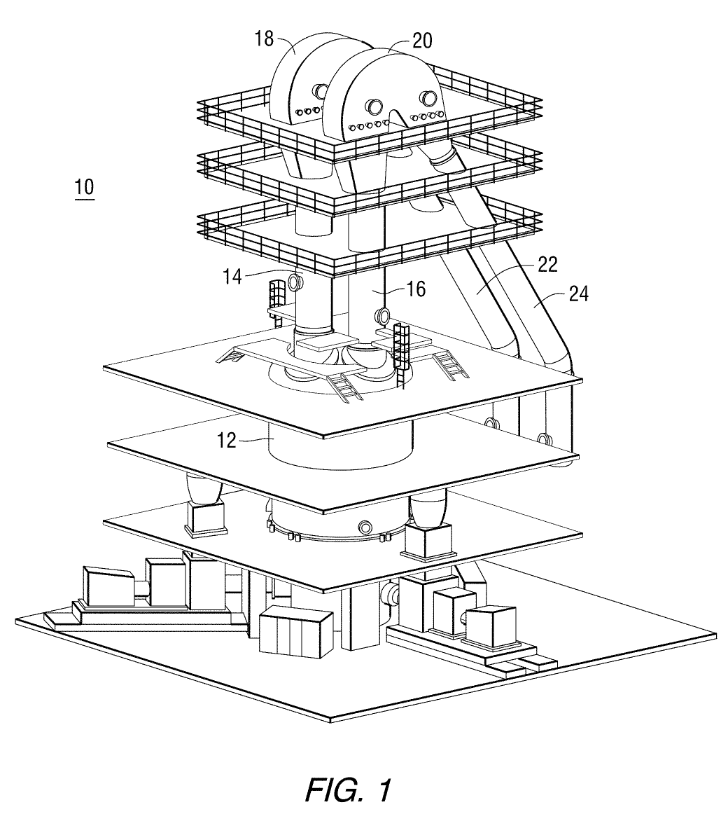

FIG. 1 is an isometric view of an example of a gasification apparatus 10 including a plasma gasification reactor vessel 12. The reactor vessel can be used to process various feed material to produce a gas that exits the roof of the reactor vessel. Various gasification reactor designs are known in the art. One example of a plasma gasification reactor is described in US Patent Application Publication US2012/0199795, which is incorporated by reference herein.

As shown in the example of FIG. 1, two ducts 14, 16, termed “uptakes”, are employed to exhaust syngas from a gasifier reactor vessel. Elbows 18, 20 receive gas from the uptakes and direct the gas in a generally downward direction to ducts 22, 24. The ducts direct the gas to processing equipment (not shown) that remove particulate material and other contaminants.

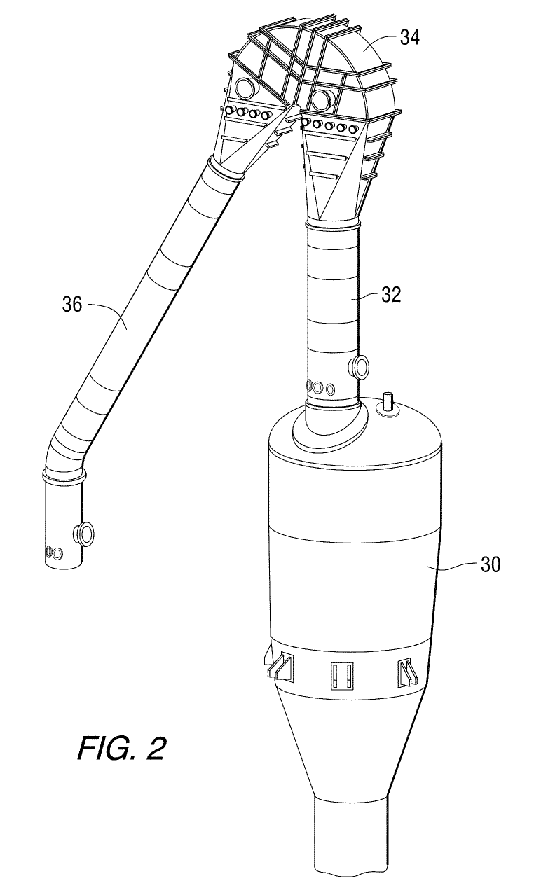

FIG. 2 is an isometric view of another example of a plasma gasification reactor vessel 30 having an uptake duct 32 connected to a self cleaning elbow 34, which directs the gas in a duct 36.

FIGS. 1 and 2 are examples of plasma gasification reactors (PGR) that may be used for gasification and/or vitrification of various process materials. One manner of operating such a PGR is for gasifying feed material to produce a syngas from a feed material. The feed material may include, as examples, one or more of materials such as biomass, municipal solid waste (MSW), coal, industrial waste, medical waste, hazardous waste, tires, or incinerator ash.

A gasification process performed in gasification reactors can produce a syngas with a relatively high particulate loading (e.g., solids content potentially exceeding 1,000 kg/h), which must be conveyed to downstream gas cleaning equipment for particulate matter (PM) and contaminant removal.

Elbows in the exhaust gas ductwork should be designed to operate at the pressures and temperatures of gases exiting gasification reactors, and to handle the particulate loading in gas supplied from the reactor, while minimizing particulate material build-up within the elbows.

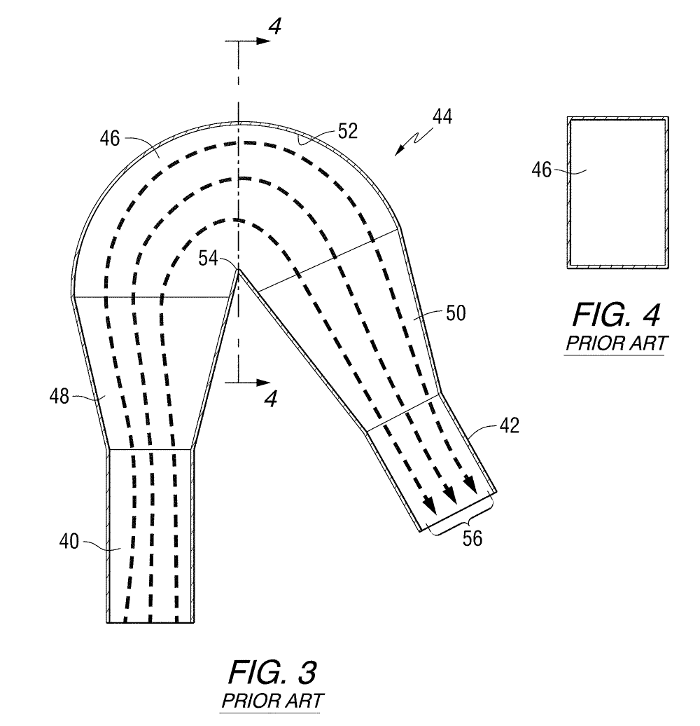

A schematic representation of a common elbow geometry employed to handle gas flows with high PM content is illustrated in FIG. 3. FIG. 4 is a cross-sectional view of the elbow of FIG. 3 taken along line 4-4.

The elbow of FIGS. 3 and 4 is termed a “self-cleaning elbow” and has been widely utilized in a number of applications, including the cement and smelting industries.

FIG. 3 shows an inlet duct 40 and an outlet duct 42 connected to a “self-cleaning” elbow 44. The inlet and outlet ducts typically have a circular cross-section. The elbow includes a curved portion 46 having a generally rectangular cross-section, an input transition portion 48 and an outlet transition portion 50. The transition portions couple the inlet and outlet ducts, which have a circular cross-sectional shape, to the curved portion, which has a rectangular cross-sectional shape. There are two key features to this geometry which reduce particulate material build-up within the elbow. First, the upper surface 52 of the elbow provides a sweeping curve which re-directs gas flow. The high velocity gas and PM flowing along the upper surface 52 effectively scours any particulate material build-up which may accumulate on this surface due to impaction, while the rectangular cross-section ensures uniform scouring of the entire surface (a round cross-section may lead to channeling of PM and incomplete scouring of build-up). Second, a lower surface with a relatively sharp bend 54 presents very little horizontal surface on which particles can accumulate (particles falling onto this surface will tend to fall by gravity into either the inlet duct 40 or the outlet duct 42). Arrows 56 illustrate the flow of gas through the elbow.

Elbows having geometries as illustrated in FIGS. 3 and 4 have been widely employed in a number of applications. However, the elbow geometry of FIGS. 3 and 4 includes a curved portion having a rectangular cross-sectional shape, which is not effective at withstanding any significant pressure differential between the internal environment of a gasification reactor and the external (ambient) environment. It can be understood by those skilled in the art that the rectangular cross-section of the elbow of FIGS. 3 and 4 is not optimal for handling any significant pressure differential between the internal gas flow environment and the external environment.

Embodiments of the invention can have an overall geometry that is generally similar to the elbow of FIGS. 3 and 4, but include features making the elbow suitable for use in the high pressure ductwork of gasifier systems.

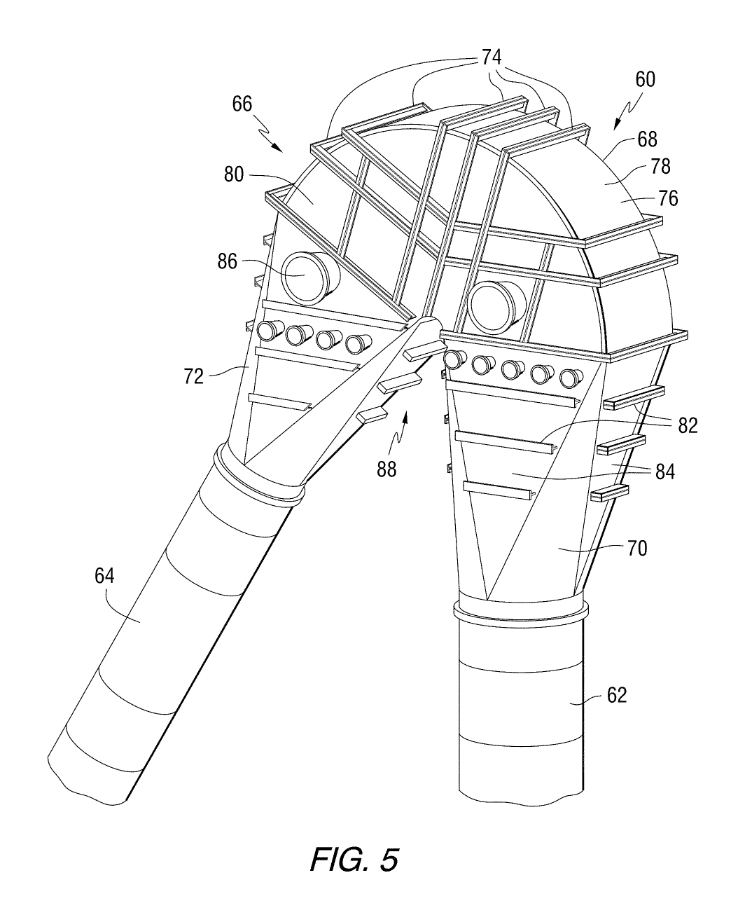

FIG. 5 is a side view of a self cleaning elbow assembly 60 in accordance with an embodiment of the invention. FIG. 5 shows an inlet duct 62 and an outlet duct 64 connected to a “self-cleaning” elbow 66. The inlet and outlet ducts can have a circular cross-sectional shape. The elbow includes a curved portion 68 having a generally rectangular cross-sectional shape, an input transition portion 70 and an outlet transition portion 72. The transition portions couple the circular cross-section inlet and outlet ducts to the rectangular cross-section curved portion.

The elbow of FIG. 5 includes elements that structurally reinforce the elbow to allow the elbow to withstand a range of pressure loads, caused by a differential pressure between the internal and external environments. A plurality of stiffeners 74 are positioned adjacent to an external surface 76 of the curved portion 68 to provide structural reinforcement for pressure loadings. The stiffeners extend across the outer surface 78 of the curved portion of the elbow, and also extend along the generally flat sides of the curved portion of the elbow. Only one of the generally flat sides 80 is shown in FIG. 5, but it will be understood that a second generally flat side exists on the elbow opposite generally flat side 80.

Additional stiffeners 82 are positioned adjacent to generally flat sides 84 of the transition portions 70, 74. Sight glasses 86 are provided to allow visual inspection of the interior of the elbow. As more fully described below, the stiffeners can be constructed to provide the desired mechanical strength, and also to reduce the possibility of hot or cold spots occurring along the walls of the elbow. In some embodiments, the structural reinforcement of the self-cleaning elbow can allow the elbow to withstand internal design pressures ranging from about −34.5 kPag to about 50 kPag. In other embodiments, the structural reinforcement of the self-cleaning elbow can allow the elbow to operate in combination with a pressurized reactor that would operate at 300 kPag or more.

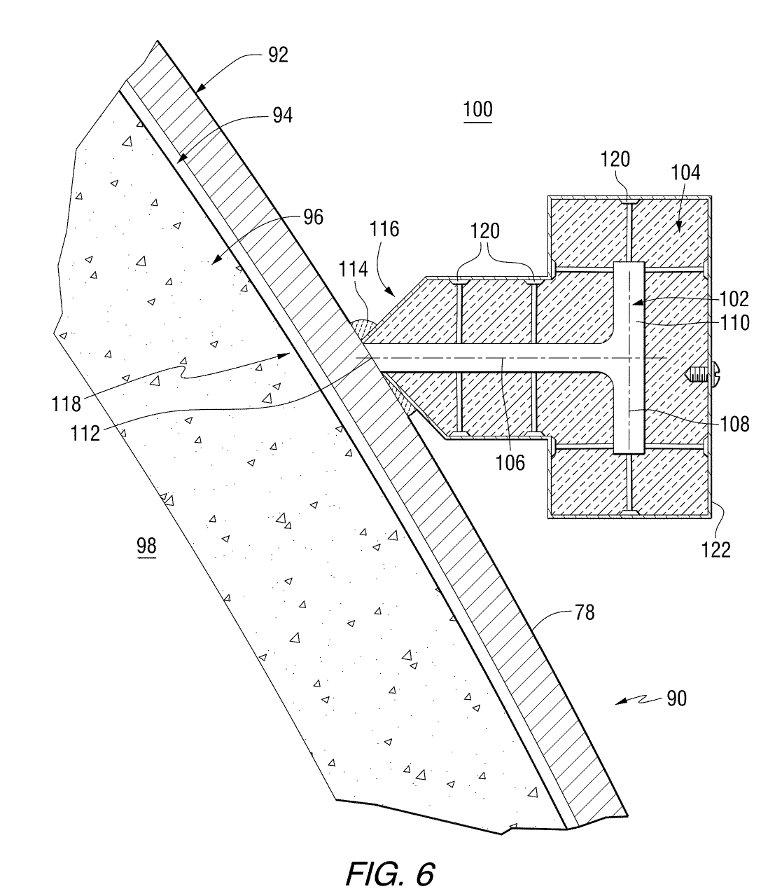

The bottom wall of the curved portion of the elbow has a radius in a crotch area 88 to reduce stress in this region. This differs from the sharp bend 54 in the elbow of FIG. 3. The refractory layer (96 in FIG. 6) is shaped internally at the crotch to achieve the desired internal dimensions for self cleaning.

Stiffeners are used to minimize the required thickness of the duct. The stiffener arrangement in the crotch region is configured to support the elbow, but not over-stiffen it. If the walls of the elbow are too rigid high thermal stresses will result. The stiffener design can be more robust than what is required for shell strength due to pressure. This is because of the internal refractory which may fail if the shell deflects too much. Thickness of insulation around the duct stiffeners can be selected to minimize deflections and achieve the desired shell and stiffener temperatures.

FIG. 6 is a cross-sectional view of a portion of the elbow of FIG. 5. In the embodiment of FIG. 6, the wall 90 of the curved portion of the self-cleaning elbow of FIG. 5 is shown to include a metal shell 92, an insulation layer 94, and a refractory layer 96. Also shown are the internal gas flow environment 98 and the external (ambient) environment 100. The metal shell can be, for example, steel; the insulating layer can be, for example, ceramic fiber blanket or semi-rigid board; and the refractory layer can be, for example, a low iron insulating castable refractory or a high alumina castable refractory. The refractory layer provides abrasion resistance and structural strength in the lining while the insulating layer ensures that the shell temperature is kept below its design limit.

The thickness and material of the insulation layer 94 and the refractory layer 96 can be selected to maintain the steel shell 92 temperature within design limits (e.g., between 120° C. and 350° C.) under all expected process conditions when the elbow is used in ductwork connected to gasification reactor (based on the thermal and corrosion protection requirements). FIG. 6 illustrates a typical stiffener arrangement, which includes a steel stiffener 102 fixed to the steel shell 92, as well as stiffener insulation 104. The stiffener 102 provides structural strength to the elbow in order to withstand the loading caused by the pressure differential between the internal environment 98 and the external environment 100. In the example of FIG. 6, the stiffener 102 includes a metallic component with an elongated first portion 106 having a generally rectangular cross-sectional shape, and a second portion 108 having a generally rectangular cross-sectional shape. The second portion is positioned adjacent to a first end 110 of the first portion and is substantially perpendicular to the first portion. The first and second portions of the stiffener together form a stiffener having a substantially T-shaped cross-section. A second end 112 of the first portion of the stiffener is positioned adjacent to the outer surface 78 of the curved portion of the elbow. The stiffener can be attached to the outer surface 78 of the elbow, for example, by a weld. Caulking material 114 can be included to prevent moisture from contacting the steel component.

There are two features of the stiffener arrangement which are employed to limit temperature differentials in the elbow assembly, in order to mitigate any issues associated with thermal expansion and contraction. First, the insulation 104 on the steel stiffener 102 is employed to prevent excessive heat dissipation to the external environment through the stiffener, which could result in a localized cool spot where the steel stiffener 102 is fixed to the steel shell 92. Second, the thickness of the insulation 104 is tapered in the area 116 near the connection point between the steel stiffener 102 and the steel shell 92. This prevents over-insulation of the steel shell 92 near the area 118, which could result in a localized hot spot. Both of these measures reduce temperature gradients that could lead to unacceptable thermal expansion and/or contraction of the assembly. In the example of FIG. 6, the insulation is secured to the steel components using a plurality of pins 120. In one embodiment, the insulation material is pushed through the pins and then clips are attached to the end of the pins to hold the insulation in place. A cladding material 122 can be positioned on the external surfaces of the thermal insulation. The cladding material protects the insulation from degradation.

The insulation on the stiffener is intended to keep the temperature of the stiffener uniform and as similar to the shell as possible. If the shell is hot and the stiffener's outer extremity is cold, the shell will tend to bow inwards which could damage the refractory layer.

In the embodiment of FIG. 6, the insulation completely surrounds the metal bar in the stiffener.

The stiffener is preferably welded to the shell to add the appropriate stiffness to the shell. In other embodiments, it may be possible to bolt the stiffener to the shell. A bolted connection may require some form of rigid insulation between the stiffener and the shell and sliding joints for the thermal expansion differences, but this might potentially avoid having to insulate the stiffener.

The angle of taper of the insulation can be, for example, about 45°. Tapering the insulation to a point adjacent to the shell of the elbow avoids extra insulation adjacent to the shell and consequently avoids overheating of the shell in the region of the stiffeners. A balance needs to be struck between preventing the stiffener from acting like a fin and over insulating the region.

As shown in FIG. 5, stiffeners similar to that shown in FIG. 6 can also be positioned adjacent to generally flat surfaces of the transition portions of the elbow. These stiffeners can have the same construction as the stiffener illustrated in FIG. 6. In one embodiment, these stiffeners are oriented perpendicular to the flat surfaces that are exposed to pressure.

Various design objectives have been established in order to accommodate the significant process variations (e.g. gas flow rate, gas temperature, and gas contaminant levels) that may occur during operation of elbows coupled to MSW gasifiers. For example, the self-cleaning elbows employed in the ductwork for gasifier systems can be designed to meet several design elements including gas flow geometry; thermal and corrosion protection; and structural reinforcement for pressure loadings.

For thermal and corrosion protection, in some embodiments such as where the elbow is used in an outlet duct of a gasification reactor, it is desirable to limit the maximum design temperature of steel elbow shell and steel stiffeners to 350° C., since temperatures above this limit may result in an unacceptable reduction in steel strength, as dictated by pressure vessel design codes. In addition, it may be desirable to limit the minimum design temperature of steel elbow shell to 120° C., since temperatures below this limit may result in condensation of chemical species such as H₂S on the steel shell, with a resultant risk of corrosion. Corrosion by contaminants within the gas stream (e.g., primarily hydrogen sulfide (H₂S)), may occur when the temperature of metallic surfaces (e.g. the steel shell of the elbow) drops below a specified temperature.

It may also be desirable to limit temperature differentials across the steel elbow shell and steel stiffeners in order to minimize differential thermal expansion and contraction, which may compromise the structural integrity of the assembly.

Various embodiments can also be designed to withstand a maximum internal gas temperature of 1,300° C., in conjunction with a minimum exterior (ambient) temperature of 32° C.

Embodiments of the elbow may be suitable for use in gas handling applications involving a significant pressure differential between the internal gas flow environment and the ambient environment, and gas handling applications with significant variability in gas temperature and gas contaminant levels (which present technical challenges related to corrosion protection and management of thermal expansion and contraction).

While particular aspects of the invention have been described above for purposes of illustration, it will be evident to those skilled in the art that numerous variations of the details of the disclosed embodiment may be made without departing from the invention as defined in the appended claims.

What is claimed is:

1. An exhaust elbow comprising:
an inlet;
an outlet;
a curved gas guiding duct between the inlet and the outlet; and
a plurality of thermally insulated stiffeners connected to an external surface of the curved gas guiding duct, each of the stiffeners including a metallic component and thermal insulation adjacent to at least a portion of a surface of the metallic element.

2. The exhaust elbow of claim 1, wherein the metallic component of each of the thermally insulated stiffeners comprises a first bar having a generally rectangular cross-sectional shape; and the thermal insulation comprises a layer of thermal insulating material positioned around the first bar; and wherein a first edge of the bar is connected to an external surface of the curved gas guiding duct.

3. The exhaust elbow of claim 2, wherein a thickness of the layer of thermal insulating material is tapered in a region adjacent to the external surface of the curved gas guiding duct.

4. The exhaust elbow of claim 2, wherein each of the thermally insulated stiffeners further comprises a second bar having a generally rectangular cross-sectional shape and being connected to a second edge of the first bar opposite the first edge of the first bar.

5. The exhaust elbow of claim 1, further comprising:
a layer of insulating material on an internal surface of the curved gas guiding duct.

6. The exhaust elbow of claim 5, further comprising:
a refractory layer on the layer of insulating material.

7. The exhaust elbow of claim 1, wherein the curved gas guiding duct includes a shell having a metal layer.

8. The exhaust elbow of claim 1, wherein the curved gas guiding duct between the inlet and the outlet and the plurality of thermally insulated stiffeners are configured to withstand internal pressures ranging from about −34.5 kPag to about 50 kPag.

9. The exhaust elbow of claim 1, wherein the curved gas guiding duct includes a curved internal surface and a crotch area opposite the curved internal surface, and the crotch area includes a radius configured to reduce stress in the crotch area.

10. The exhaust elbow of claim 1, further comprising;
a plurality of pins positioned to secure the thermal insulation to the metallic components.

11. The exhaust elbow of claim 1, further comprising;
a cladding layer on the thermal insulation.

12. The exhaust elbow of claim 1, wherein the thermal insulation completely surrounds exposed surfaces of the metallic components.

13. The exhaust elbow of claim 1, wherein the metallic components are welded to the curved gas guiding duct.

14. The exhaust elbow of claim 1, wherein a thickness of the thermal insulation is tapered at an angle of about 45° in a region adjacent to the curved gas guiding duct.

15. The exhaust elbow of claim 1, wherein the metallic components are positioned perpendicular to an external surface of the curved gas guiding duct.

16. The exhaust elbow of claim 1, further comprising:
an input transition portion connected between the inlet and the curved gas guiding duct; and
an outlet transition portion connected between the outlet and the curved gas guiding duct.

17. The exhaust elbow of claim 16, further comprising:
additional thermally insulated stiffeners connected to flat external surfaces of the inlet transition portion and the outlet transition portion.
